(19) United States
(12) Patent Application Publication
(10) Pub. No.: US 2021/0227670 A1
(43) Pub. Date: Jul. 22, 2021

(54) Lighting Control System And A Method For Providing An Ambiance

(71) Applicant: Lighting Fundamentals IP B.V., Hilversum (NL)

(72) Inventors: Robert Jaap Timmer, Hilversum (NL); Jeroen Elles Wilhelmus Martinus Dalderop, Hilversum (NL); Gerry Vermeulen, Hilversum (NL)

(21) Appl. No.: 16/096,666

(22) PCT Filed: Apr. 25, 2017
(86) PCT No.: PCT/NL2017/050267

§ 371 Date: Oct. 25, 2018

(30) Foreign Application Priority Data
Apr. 25, 2016 (NL) 2016673

(51) Int. Cl. H05B 47/155; H05B 47/11; H05B 47/19; H05B 47/165

(52) U.S. Cl. CPC H05B 47/155; H05B 47/165; H05B 47/19; H05B 47/11

(57) ABSTRACT

A lighting control system configured to cooperate with a light source for illuminating an object in a space to recreate an ambiance, the lighting control system arranged to input a setting related to a scene intended for the space to the light source via a user interface;

wherein the lighting control system further comprises a configuration module arranged in signal communication with the user interface for:
a) providing at least one preset scene from a plurality of preset scenes according to:
   i) a preset type of space in which the light source is positioned from a plurality of preset types of spaces; and
   ii) a preset type of object that said light source is intended to illuminate from a plurality of preset types of objects; and
b) inputting the setting to the light source according to the at least one preset scene of the plurality of preset scenes.

### FIELD OF THE INVENTION

The invention relates to a lighting control system configured to cooperate with at least one light source for illuminating an object in a space to define a scene and a method for providing an ambiance.

### BACKGROUND OF THE INVENTION

When defining a space comprising objects, such as a room with furniture, the illumination provided by light sources arranged in the space to illuminate an object or a plurality of objects have to be adjusted. For the same space, the light sources may provide different illumination properties to create an ambiance according to different activities intended the space even if the space comprises the same objects.

Lighting control systems are known in the art and they offer the possibility to control the settings, such as intensity and colour, for the light sources arranged in the space. They may also offer the possibility to store and recall combinations of settings for multiple light sources, which together create an optimized ambiance for a specific activity. These combinations of settings are commonly referred to as scenes. Said lighting control systems may comprise inputs and outputs related to lighting control in signal communication with a user interface for controlling said light sources. The user interface is configured to input the appropriate setting or settings to the corresponding light source or plurality of light sources as defined for the selected scene.

However, defining the scenes is usually a time consuming activity since the appropriate settings are adjusted manually by a user using the lighting control system via a trial and error approach. This problem may become even worse when there is more than one light source arranged in the space, each of them arranged for illuminating different objects arranged in the space, and the setting for each light source has to be adjusted.

### SUMMARY OF THE INVENTION

It is an object of the present invention to alleviate the above-mentioned problem. To this end, a first aspect of the invention provides a lighting control system configured to cooperate with a light source for illuminating an object in a space to recreate an ambiance, the lighting control system arranged to input a setting related to a scene intended for the space to the light source via a user interface;

wherein the lighting control system further comprises a configuration module arranged in signal communication with the user interface for:
a) providing at least one preset scene from a plurality of preset scenes according to:
   i) a preset type of space in which the light source is positioned from a plurality of preset types of spaces; and
   ii) a preset type of object that said light source is intended to illuminate from a plurality of preset types of objects; and
b) inputting the setting to the light source according to a preset scene of the plurality of preset scenes.

A second aspect of the present invention provides a method for recreating an ambiance for a space comprising an object, the method using:
a) a light source configured to illuminate the object according to a scene; and
b) a lighting control system comprising a user interface configured to input the light source with a setting related to the scene;
   and the method comprising the step of defining the scene via the user interface to input the light source with the setting;
   wherein the lighting control system further comprises a configuration module in signal communication with the user interface for:
a) providing at least one preset scene from a plurality of preset scenes according to:
   i) a preset type of space from a plurality of preset types of spaces; and
   ii) a preset type of object from a plurality of preset types of objects; and
b) inputting the setting to the light source according to the at least one preset scene of the plurality of preset scenes;
   and wherein the step of defining the scene further comprises the steps of:
   selecting the preset type of space in which the light source is located;
   selecting the preset type of the object that the light source is intended to illuminate; and
   selecting one of the at least one preset scene selected to input the setting to the light source.

### DETAILED DESCRIPTION OF THE INVENTION

A first aspect of the invention concerns a lighting control system according to claim 1. In this way, the appropriate scenes for a lighting system and the corresponding settings for a scene can be selected in a more convenient way.

The lighting control system according to the invention comprises a user interface configured to input a setting to a light source. It may be possible that the user interface is also configured to detect the light sources in the space.

The lighting control system further comprises a configuration module in signal communication with the user interface. The user interface may comprise the configuration module. The configuration module may comprise a hard device, a software program, an electronic circuit or combinations thereof and is arranged for providing at least one preset scene with corresponding settings for the light source from a plurality of preset scenes with corresponding settings. Thus, the lighting control system is configured to store a plurality of preset scenes and their related settings. The at least one preset scene is then input to the user interface. In this way, the user interface is capable of adjusting the setting of the at least one light source by selection of a preset scene by the user of the lighting control system.

The scene provided by the configuration module is done according to the type of space in which the light source is arranged. The selection of light source settings for each scene by the configuration module is done according to the type of light source and the type of object said light source is intended to illuminate.

Once the at least one preset scene is provided by the configuration module, said at least one preset scene can be input by the configuration module to the user interface. It is possible that the configuration module provides more than at least one preset scenes, all these provided preset scenes being scenes suitable for said space. All these provided scenes can then be input by the configuration module to the user interface. Thus, the user of the lighting control system may select one of these scenes, which triggers the user interface to input the corresponding settings to the light source. Thus, the creation of a scene and the corresponding settings for the associated light source requires no manual adjustment from the user of the setting to be input to the light source.

In the lighting control system according to the invention, the type of space corresponds to a preset type of space from a plurality of preset types of spaces. Similarly, the type of object corresponds to a preset type of object from a plurality of preset types of objects. The lighting control system is configured to provide said pluralities. For example, these pluralities may be provided by an input module of said lighting control system configured to do this. Said input module or said user interface may comprise buttons or a touchscreen for the selection of the preset type of space and the preset type of object by the user.

In an embodiment, the user interface comprises:
a) a display screen; and
b) a categorization module for providing a plurality of categorization tags for the light source in the display screen;
   wherein the plurality of categorization tags comprises:
   i) a first categorization tag configured to provide when selected the plurality of preset types of spaces; and
   ii) a second categorization tag configured to provide when selected the plurality of preset types of objects;
      and wherein the categorization module is also configured to input the configuration module with the preset type of the space and the preset type of the object. In this way, the user interface provides the plurality of preset types of spaces and the types of preset objects. Further, said pluralities are provided in an orderly way.

The categorization module may comprise a hard device, a software program, an electronic circuit or combinations thereof for providing the first categorization tag and the second categorization tag in a first categorization page shown in the display screen of the user interface. Then, by selecting one of said first categorization tag or second categorization tag, the pluralities of preset types of spaces or preset types of objects are provided in said first categorization page or a subsequent categorization page.

In a different example, the module tag may provide the first categorization tag in the first categorization page and once one preset type of space is selected, the second categorization tag is provided for selection of the preset type of object.

In an embodiment, the categorization module is configured to provide the second categorization tag as a sub-categorization tag of at least one preset type of space of the plurality of preset types of spaces and wherein said sub-categorization tag is configured to provide when selected a plurality of preset types of objects according to said at least one preset type of space. In this way, the plurality of preset types of objects provided is reduced since not all the preset types of objects that can be provided by the user interface are related to the preset type of space that has been selected previously. Consequently, the lighting control system allows for an even faster selection of the appropriate preset setting related to the preset scene.

In an embodiment the categorization module is further configured to provide a third categorization tag as a further sub-categorization tag of at least one preset type of space and/or one preset type of object, the third categorization tag being configured to provide when selected a plurality of preset uses intended for said at least one preset type of space or preset type of object, and wherein the configuration module is further configured to provide the at least one preset scene according to a preset use from the plurality of preset uses. In this way, the lighting control system allows for a better definition of the scene and, consequently, the selection provided by the configuration module is more accurate.

In an embodiment, the categorization module is further configured to provide a fourth categorization tag, the fourth configuration tag being configured to provide when selected a plurality of preset types of light sources, and wherein the configuration module is further configured to provide the at least one preset scene according to a preset type of light source from the plurality of preset types of light sources. In this way, the appropriate setting for the light source is selected more accurately. Since there are different types of light sources, e.g. bulbs, spot lights, light strips, etc., the properties of the light may depend on said type. As an example, the illumination provided may vary depending on the maximum light output, the color temperature or the beam angle of the light. Thus, the type of light source may have an impact on the illumination intended for a scene.

In an embodiment, the lighting control system further comprises a memory module for associating the at least one preset scene with a trigger event, and wherein the categorization module is further configured to provide a fifth categorization tag configured when selected to provide the at least one preset scene according to the trigger event. In this way, the preset setting required for providing a desired scene can be input by the trigger event. The trigger event can be a key word related to said preset scene, such as the use, real time, activity related to the scene, etc.

In an embodiment, the display screen is arranged in a touchscreen. In this way, the information can be provided to the lighting control system more easily and even a more straightforward by a user. In general, the user interface is arranged in a smartphone or a tablet.

In an embodiment, the lighting control system further comprises a time module configured to input the configuration module with real time and/or day and wherein said configuration module is further configured to provide the at least one preset scene according to the real time and/or day. In this way, the selection of the appropriate scene is achieved faster and even without the intervention of the user, since the setting to be input to the light source may depend on the real time and/or the day.

A second aspect of the invention concerns a method for providing a scene for a space comprising an object according to claim 10. The space comprises the object arranged in said space, and the object is illuminated by a lighting control system. It is preferred that the lighting control system for the method is the lighting control system discussed in the above-mentioned embodiments.

The lighting control system comprises a user interface arranged for imputing at least one light source with an appropriate setting, such that said at least one light source illuminates the object accordingly to recreate a scene for said space. The user interface may be also configured to detect the light source of said space. The method according to the invention allows a user of the lighting control system to obtain the appropriate setting faster, even if said user has little or even no knowledge about illumination and settings required for defining scenes.

In the method, the configuration module provides at least one preset scene with the associated light source settings required to create the scene intended for the space. The at least one preset scene is then input to the user interface, together with the appropriate associated settings for the light source. The user may then select said at least one preset scene, which triggers the lighting system to input the associated settings to the light source. It is possible that there is more than at least one preset scene provided by the configuration module and offered by the user interface to the user, and the user may select one of them to trigger the lighting system to input the associated settings to the light source. Even in this case, the method of defining the scene is faster, since there is no manual adaptation of the setting and even if there is a trial and error, the number of possibilities offered has been drastically reduced by the user interface due to the type of space and the type object selected by the user.

The at least one preset scene can be provided by the control module since the type of space and the type of object has been defined by the selection, made by the user, of a preset type of space and a preset type of object provided by the lighting control system. The preset type of space and the preset type of object is provided from a plurality of preset types of spaces and a plurality of preset types of objects stored by the lighting control system.

In an embodiment, the lighting control system is further configured to provide a plurality of preset types of uses intended for the selected preset type of space or the selected preset type of object, wherein the configuration module is further configured to provide the at least one preset scene according to a preset type of use from the plurality of preset types of uses, and wherein the method further comprises the step of selecting the preset type of use for the light source. In this way, the scene can be defined faster since the control module may provide the at least one preset scene more accurately.

In an embodiment, the lighting control system is further configured to provide a plurality of preset types of light sources; wherein the configuration module is further configured to provide the at least one preset scene according to a preset type of light source from the plurality of preset types of light sources; and wherein the method further comprises the step of selecting the preset type of light source. In this way, the scene can be defined faster since the setting to be input to the light source may also depend on the type of said light source.

In an embodiment, the lighting control system further comprises a time module configured to determine the real time and/or day, wherein the time module is in signal communication with the configuration module and wherein said configuration module is configured to provide the at least one preset scene according to the real time and/or day. In this way, the scene can be defined faster, since the illumination provided by the light source may depend on real time and/or day.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 shows an embodiment of a lighting control system according to the invention.

FIG. 2 shows a schematic view of the cooperation between a user interface and a configuration module of the lighting control system depicted in FIG. 1.

FIG. 3 shows a flow chart of a first method for providing a scene using the lighting control system depicted in FIG. 1.

FIGS. 4A to 4E show different views of a screen of the user interface used in the method depicted in FIG. 3.

FIG. 5 shows a flow chart of a second method for providing a scene using the lighting control system depicted in FIG. 1.

FIG. 6A to 6C show different views of the screen of the user interface used in the method depicted in FIG. 5.

### DETAILED DESCRIPTION OF THE DRAWINGS

It should be noted that items which have the same reference numbers in different figures, have the same structural features and the same functions. Where the function and/or structure of such item has been explained, there is no necessity for repeated explanation thereof in the detailed description.

It should also be noted that the above-mentioned embodiments illustrate rather than limit the invention, and that those skilled in the art will be able to design many alternative embodiments.

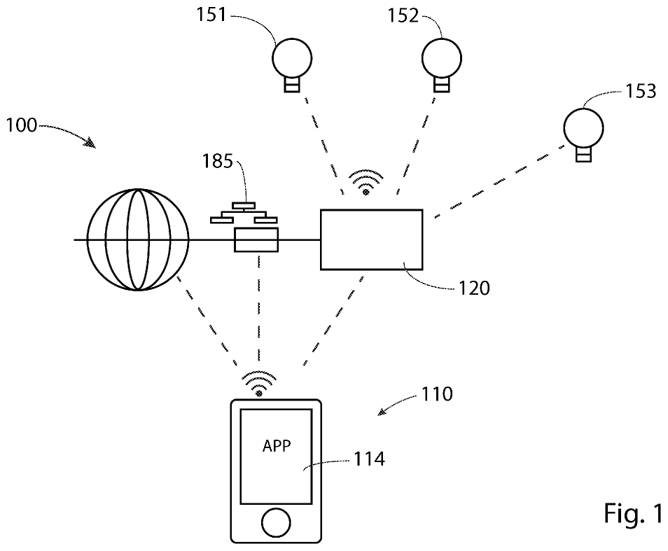

FIG. 1 depicts an embodiment of a lighting control system 100 according to the invention. The lighting control system 100 comprises a user interface 110 in signal communication with a bridge 120 via a router 130 and a network 185.

The lighting control system 100 is configure to input settings via the bridge 120 to a first light source 151, a second light source 152 and a third light source 153, each of them being arranged in a space, in the present example a dining room (not shown). The first light source 151 is arranged for illuminating a dining table placed in the living room (not shown). The second light source 152 is arranged for illuminating a television set (not shown) and third light source 153 a sofa (not shown).

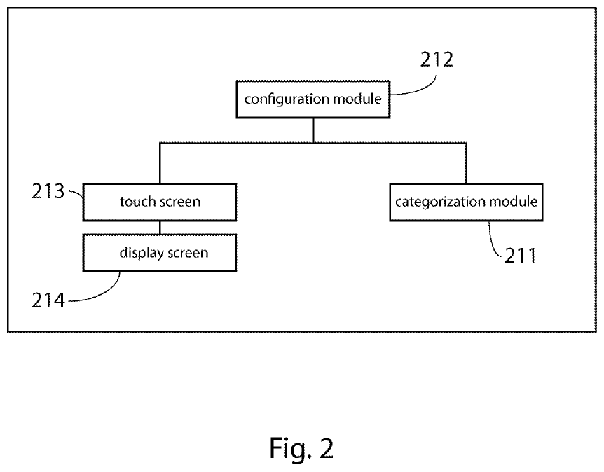

In the present embodiment, the user interface 110 of the lighting control system 100 is a tablet PC 110. As shown in FIG. 2, the tablet PC 110 comprises a categorization module 211, a configuration module 212 and a touchscreen 213 in communication with each other. The categorization module 211 and the configuration module 212 may comprise a hard device, a software program, an electronic circuit or combinations thereof. The touchscreen 213 comprises a display screen 214.

In said embodiment, the categorization module 211 is configured to store a plurality of preset types of spaces and a plurality of preset types of objects intended to be illuminated. Plus, the categorization module 211 is also configured to display said information in an orderly way via categorization tags shown in the display screen 214, as will be explain later. In this way, the user may select and interact with this information via the touchscreen 213.

The configuration module 212 is configured to store a plurality of preset settings and also to provide at least one preset setting from said plurality of preset settings. The at least one preset setting is provided according to the information stored in the categorization module 211 and selected during a method of use of the lighting control device 100, as discussed below.

The lighting control system 100 may define different scenes for the living room by providing appropriate settings to each of the first light sources 151, 152 and 153. As a mode of example, a scene might be “watching television”, or “having dinner”. If the light scene intended for the living room is “watching television”, the settings to be input to the light source 151, 152 and 153 to define said scene are not the same as those required by said light sources 151, 152 and 153 when the scene is “having dinner”.

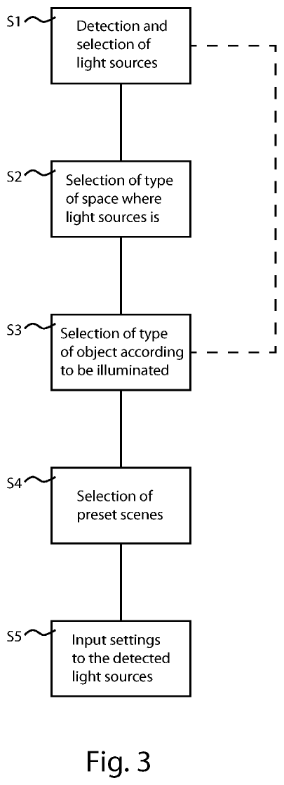

FIG. 3 depicts a flow chart of a first method for providing a scene using the lighting control system 100. In the present example, the scene would be for said living room for watching television.

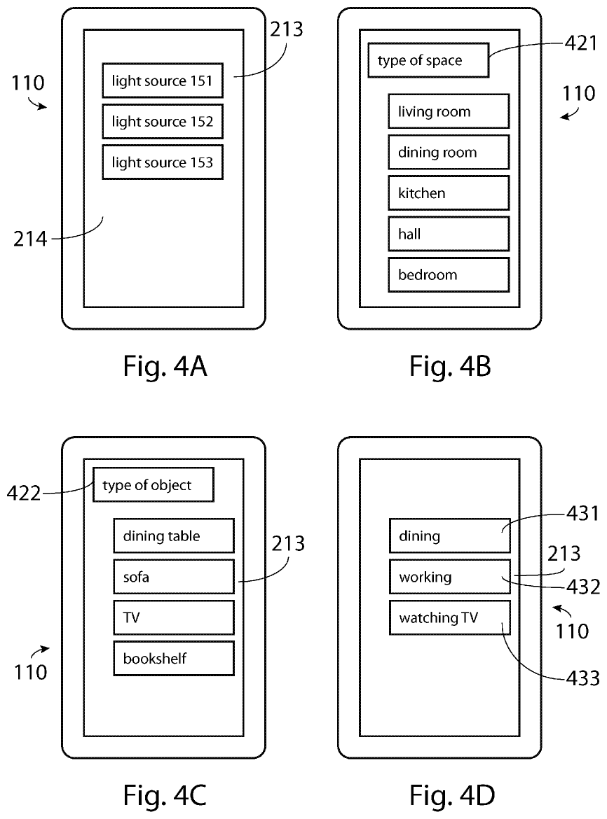

As shown in step S1, the method starts when the user interface 110 detects the first light source 151, the second light source 152 and the third light source 153 of the living room. Said lighting sources 151, 152 and 153 are then displayed in the display screen 214 of the user interface 110, as shown in FIG. 4A. The user can then select one of said light sources via the touchscreen 213. As a mode of example, the following steps will be explained when the first light source 151 has been selected.

Once the first light source 151 is selected via the touchscreen 213, the second step of the method is the selection of the type of space in which said light source 151 is arranged, which corresponds to step S2 of FIG. 3. The categorization module 211 provides in the display screen 214 a first categorization tag 421 in a first categorization page, as depicted in FIG. 4B. Once the first categorization tag 421 is selected via the touchscreen 213, a plurality of preset types of spaces is provided in said first categorization page. In the present example, the preset type of space to be selected is a “living room”.

The following step S3 in the method is the selection of the type of object that said light source 151 is intended to illuminate. In the present example, this is done because the categorization module 212 provides a second categorization tag 422 in a second categorization page as depicted in FIG. 4C. Once the second categorization tag 422 is selected via the touchscreen 213, a plurality of preset objects related to the type of space already selected is provided in the display screen 214. Since the first light source 151 is intended to illuminate the dining table, this preset type of object (“dining table”) is selected via the touchscreen 213.

Once then the preset type of space and the preset type of object for said first light source 151 have been selected, the configuration module 212 shows again the light sources detected for selection and the same steps S1-S3 of the method will be also applied to the light sources 152 and 153.

Once the method has been applied for the light sources 151, 152 and 153, the configuration module 212 provides at least one preset scene from the plurality of preset scenes and provides said at least one preset scene in a third categorization page via the display screen 214 of the user interface 110. In the present example, the configuration module 212 provides three different preset tags related to three different preset scenes, as depicted in FIG. 4D. A first preset tag 431 relates to a scene for providing a illumination according to “having dinner” at the dining table, a second preset tag 432 relates to a scene for providing illumination for “working” at said dining table, and a third preset tag 433 relates to a scene for “watching TV”, which does not involve any activity at said dining table. The user of the lighting control system may select one of these scene tags which correspond to a step S4 in the method. In the present example it will be “watching television”, and once the scene tag is selected, the corresponding settings is input to the light sources 151, 152 and 153, which correspond to a step S5.

The lighting control system 100 of the present example further comprises a time module (not shown) configured to input the configuration module 212 with real time and/or day. This information also helps for the selection of the preset settings, since the amount of natural light in the living room and/or the intention of said living room may be different according to the real time and/or day. Information about the amount of natural light may be input to the configuration module 212 via the network 185. On the other hand, the possible uses of the living room related to the real time may be already stored in said configuration module 212 or programmed by the user under a keyword.

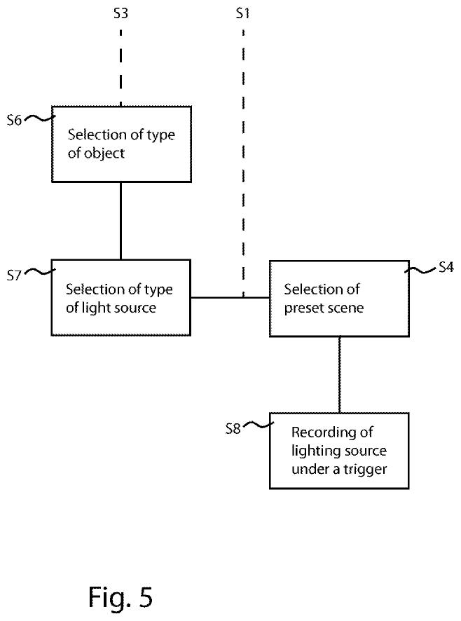

A second example of the method is depicted in FIG. 5. In the second example, the method further comprises steps S6-S8 in addition to the steps S1-S3. By addition of the method steps S6-S8, the list of preset scenes provided by the configuration module 212 is refined, as will be shown below.

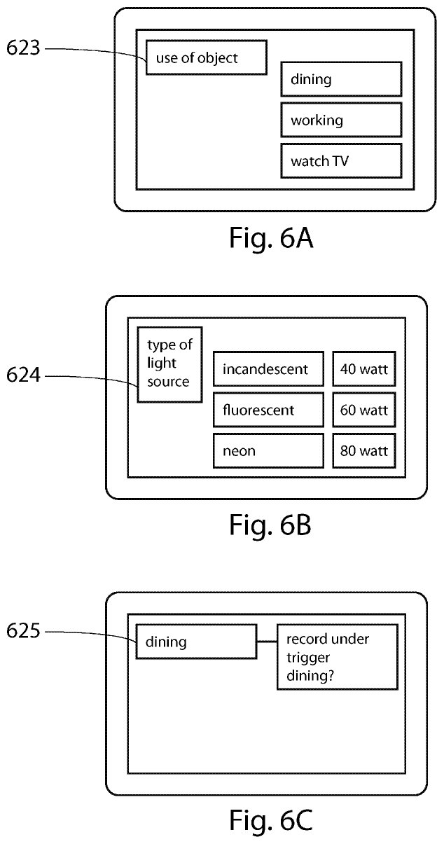

A step S6 of the second example of the method corresponds to a selection of a type of use intended for the object to be illuminated by the first light source 151. Once the type of object has been selected according to the step S3, the categorization module 211 provides a third categorization tag 623 in a third categorization page, as depicted in FIG. 6A. By selection of said third categorization tag 623 via the touchscreen 213, a plurality of preset types of uses are displayed in the display screen of the user interface 110, as depicted in said FIG. 6A. Plus, the plurality of preset types of uses are related to the type of space and the type of object selected in steps S2 and S3.

The control lighting system 100 also allows for selection of a preset type of light source, which corresponds to step S7 of the second example of the method. In this way the categorization module 211 provides a fourth categorization tag in a fourth categorization page 624 displayed in the display screen, as shown in FIG. 6B. Once the fourth categorization tag is selected via the touchscreen 213, a plurality of preset types of light sources is provided in said fourth categorization page. The user can select one of them, which is then input to the configuration module 212 to be taken into account for selection of the preset settings.

The method steps S5-S6 are to be applied also to the light sources 152 and 153 detected and selected in step S1 in order to define the scene for the living room according to step S4.

Finally, once the scene for the living room has been defined, the preset scene selected by the user for the light sources 151, 152 and 153 may be registered in the memory module under a keyword, as depicted in FIG. 6C. The keyword may remind the user the use of said scene in order to reproduce said scene when needed. The registered preset setting can be recovered later by selection of a fifth categorization tag (625) displayed in a fifth categorization page, which will provide tags with all the keywords recorded for said scenes. Further, the lighting control system may also comprise a command module (not shown) for inputting said settings according to a schedule recorded by the user.

1. A lighting control system (100) configured to cooperate with a light source (151, 152, 153) for illuminating an object in a space to create an ambiance, the lighting control system (100) arranged to input a setting related to a scene intended for the space to the light source (151, 152, 153) via a user interface (110);
wherein the lighting control system (100) further comprises a configuration module (212) arranged in signal communication with the user interface (110) for:
a) in response to user input from the user interface providing to the user interface at least one preset scene (431, 432, 433) from a plurality of preset scenes according to:
i) a preset type of space in which the light source (151, 152, 153) is positioned from a plurality of preset types of spaces; and
ii) a preset type of object that said light source (151, 152, 153) is intended to illuminate from a plurality of preset types of objects for selection by a user of a preset scene from the at least one preset scene; and
b) in response to the selected preset scene by the user from the user interface inputting the setting to the light source (151, 152, 153) according to the selected preset scene.

2. The lighting control system (100) according to claim 1, wherein the user interface (110) comprises
a) a display screen (214); and
b) a categorization module (211) for providing a plurality of categorization tags for the light source (151, 152, 153) in the display screen (214),
wherein the plurality of categorization tags comprises:
i) a first categorization tag (421) configured to provide when selected the plurality of preset types of spaces to the display screen; and
ii) a second categorization tag (422) configured to provide when selected the plurality of preset types of objects to the display screen;
and wherein the user interface is configured to enable a user to select a preset type of space and a preset type of object and the categorization module (211) is also configured to supply to the configuration module (212) the selected preset type of the space and the preset type of the object.

3. The lighting control system (100) according to claim 2, wherein the categorization module (211) is further configured to provide the second categorization tag (422) as a sub-categorization tag of at least one preset type of space of the plurality of preset types of spaces and wherein said sub-categorization tag is configured to provide when selected a plurality of preset types of objects according to said at least one preset type of space.

4. The lighting control system (100) according to claim 2, wherein the categorization module (211) is further configured to provide a third categorization tag (623) as a further sub-categorization tag of at least one preset type of space and/or one preset type of object, the third categorization tag (623) being configured to provide to the display screen when selected a plurality of preset uses intended for said at least one preset type of space or preset type of object, and wherein the configuration module (212) is further configured to provide the at least one preset scene (431, 432, 433) according to a preset use from the plurality of preset uses.

5. The lighting control system (100) according to claim 2, wherein the categorization module (211) is further configured to provide a fourth categorization tag (624), the fourth categorization tag (624) being configured to provide to the display screen when selected a plurality of preset types of light sources, and wherein the configuration module (212) is further configured to provide the at least one preset scene (431, 432, 433) according to a preset type of light source (151, 152, 153) from the plurality of preset types of light sources.

6. The lighting control system (100) according to claim 2, wherein the lighting control system (100) further comprises a memory module for associating the at least one preset scene (431, 432, 433) with a trigger event, and wherein the categorization module (211) is further configured to provide a fifth categorization tag (625) configured when selected to provide the at least one preset scene (431, 432, 433) according to the trigger event.

7. The lighting control system (100) according to claim 2, wherein the display screen (214) is arranged in a touchscreen (213).

8. The lighting control system (100) according to claim 1, wherein the lighting control system (100) further comprises a time module configured to input the configuration module (212) with real time and/or day and wherein said configuration module (212) is further configured to provide the at least one preset scene (431, 432, 433) according to the real time and/or day.

9. The lighting control system (100) according to claim 1, wherein the user interface (110) is arranged in a smartphone or a tablet.

10. A method for creating an ambiance for a space comprising an object, the method using:
a) a light source (151, 152, 153) configured to illuminate the object according to a setting related to a scene; and
b) a lighting control system (100) comprising a user interface (110) configured to input the light source (151, 152, 153) with the setting related to the scene;
and the method comprising the step of selecting the setting related to the scene via the user interface (110) from a plurality of preset scenes;
wherein the lighting control system (100) further comprises a configuration module (212) for:
a) providing to the display screen at least one preset scene (431, 432, 433) from a plurality of preset scenes according to:
i) a preset type of space from a plurality of preset types of spaces; and
ii) a preset type of object from a plurality of preset types of objects for selection by a user of a preset scene from the at least one preset scene; and
b) inputting the setting related to the selected preset scene by the user to the light source (151, 152, 153);
and wherein the step of selecting the scene further comprises the steps of:
selecting the preset type of space in which the light source (151, 152, 153) is located;
selecting the preset type of the object that the light source (151, 152, 153) is intended to illuminate; and
selecting one of the at least one preset scene (431, 432, 433).

11. The method according to claim 10, wherein the lighting control system (100) is further configured to provide to the display screen a plurality of preset types of uses intended for the selected preset type of space or the selected preset type of object, wherein the configuration module (212) is further configured to provide to the display screen the at least one preset scene (431, 432, 433) according to a preset type of use from the plurality of preset types of uses, and wherein the method further comprises the step of selecting by the user the preset type of use for the light source (151, 152, 153).

12. The method according to claim 10, wherein the lighting control system (100) is further configured to provide to the display screen a plurality of preset types of light sources; wherein the configuration module (212) is further configured to provide to the display screen the at least one preset scene (431, 432, 433) according to a preset type of light source (151, 152, 153) from the plurality of preset types of light sources; and wherein the method further comprises the step of selecting by the user the preset type of light source (151, 152, 153).

13. The method according to claim 10, wherein the lighting control system (100) further comprises a time module configured to determine the real time and/or day, wherein the time module is in signal communication with the configuration module (212) and wherein said configuration module (212) is configured to provide to the display screen the at least one preset scene (431, 432, 433) according to the real time and/or day.
